(19) United States
(12) Patent Application Publication
(10) Pub. No.: US 2025/0071748 A1
(43) Pub. Date: Feb. 27, 2025

(54) DATA TRANSMISSION METHOD AND COMMUNICATION EQUIPMENT

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/726,659

(22) PCT Filed: Jan. 5, 2022
(86) PCT No.: PCT/CN2022/070382

§ 371 Date: Jul. 3, 2024

(51) Int. Cl. H04W 72/044

(52) U.S. Cl. CPC H04W 72/0473

(57) ABSTRACT

Embodiments of the present disclosure provide a data transmission method and a communication equipment. The data transmission method comprises: a terminal device monitors a first PDCCH in a first bandwidth part (BWP), and receives a PDSCH in a second BWP on the basis of the first PDCCH, the bandwidth of the first PDCCH being within a reception bandwidth of the terminal device, and the first PDCCH being used for scheduling the PDSCH.

### CROSS REFERENCE TO RELATED APPLICATIONS

The present application is a U.S. National Stage of International Application No. PCT/CN2022/070382 filed on Jan. 5, 2022, the content of which is incorporated herein by reference in its entirety.

### TECHNICAL FIELD

The present disclosure relates to the field of wireless communication technologies, and in particular, to data transmission methods and communication equipment.

### BACKGROUND

In a new radio (NR) technology, a physical downlink control channel (PDCCH) for scheduling a system information block (SIB) is transmitted in a control resource set (CORESET) 0, and a physical downlink shared channel (PDSCH) for carrying the SIB is also transmitted within a frequency range corresponding to the CORESET0.

However, at present, in addition to some terminal devices with normal functions, there exist some terminal devices with limited capability, for example, NR light terminal devices, reduced capability (RedCap) terminal devices, or other evolved terminal devices. For these terminal devices, band widths for reception may be limited, and how to implement PDSCH scheduling is an urgent problem to be solved.

### SUMMARY

According to a first aspect of the present disclosure, there is provided a data transmission method, including: monitoring, by a terminal device, a first PDCCH in a first band width part, and receiving a PDSCH in a second band width part based on the first PDCCH, where a band width of the first PDCCH is located in a receiving band width of the terminal device, and the first PDCCH is used for scheduling the PDSCH.

According to a second aspect of the present disclosure, there is provided a data transmission method, including: configuring, by a network device, a first band width part and a second band width part for a first-type terminal device, where the first band width part is used for sending a first physical downlink control channel (PDCCH) to the first-type terminal device, the second band width part is used for sending a first PDSCH to the first-type terminal device, the first PDCCH is used for scheduling the PDSCH, and a band width of the first PDCCH is located in a receiving band width of the first-type terminal device.

According to a third aspect of the present disclosure, there is provided communication equipment, for example, a terminal device, including: an antenna; a memory; a processor, connected to the antenna and the memory respectively, and configured to execute computer executable instructions stored in the memory, control reception and transmission of the antenna, and implement operations including: monitoring a first PDCCH in a first band width part, and receiving a PDSCH in a second band width part based on the first PDCCH, where a band width of the first PDCCH is located in a receiving band width of a terminal device, and the first PDCCH is used for scheduling the PDSCH.

### BRIEF DESCRIPTION OF DRAWINGS

FIG. 1 is a structural schematic diagram of a communication system according to an embodiment of the present disclosure.

FIG. 2 is a schematic diagram of a bandwidth part (BWP) according to an embodiment of the present disclosure.

FIG. 3 is a schematic flowchart of implementing a data transmission method on a terminal device side according to an embodiment of the present disclosure.

FIG. 4 is a schematic diagram of a frequency domain resource according to an embodiment of the present disclosure.

FIG. 5 is a schematic flowchart of implementing another data transmission method on a terminal device side according to an embodiment of the present disclosure.

FIG. 6 is a schematic flowchart of implementing a data transmission method on a network device side according to an embodiment of the present disclosure.

FIG. 7 is a structural schematic diagram of a communication apparatus according to an embodiment of the present disclosure.

FIG. 8 is a structural schematic diagram of another communication apparatus according to an embodiment of the present disclosure.

FIG. 9 is a structural schematic diagram of communication equipment according to an embodiment of the present disclosure.

FIG. 10 is a structural schematic diagram of a terminal device according to an embodiment of the present disclosure.

FIG. 11 is a structural schematic diagram of a network device according to an embodiment of the present disclosure.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the examples of the present disclosure. Rather, they are merely examples of apparatuses and methods consistent with some aspects of the examples of the present disclosure as detailed in the appended claims.

The terms used in the examples of the present disclosure are for the purpose of describing particular examples only, and are not intended to limit the examples of the present disclosure. Terms determined by “a”, “the” and “said” in their singular forms in the examples of the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although terms “first,” “second,” “third,” and the like may be used in the examples of the present disclosure to describe various information, such information should not be limited to these terms. These terms are only used to distinguish one category of information from another. For example, without departing from the scope of the examples of the present disclosure, first information may be referred as second information; and similarly, second information may also be referred as first information. Depending on the context, the word “if” as used herein may be interpreted as “when” or “upon” or “in response to determining”.

The technical solutions provided in the embodiments of the present disclosure can be applied to wireless communication between communication equipment. The wireless communication between communication equipment may include wireless communication between a network device and a terminal device, wireless communication between network devices, and wireless communication between terminal devices. In the embodiments of the present disclosure, the term “wireless communication” may be simply referred to as “communication”, and the term “communication” may be described as “data transmission”, “information transmission” or “transmission”.

The embodiments of the present disclosure provide a communication system. The communication system may be a communication system based on a cellular mobile communication technology. FIG. 1 is a structural schematic diagram of a communication system according to an embodiment of the present disclosure. As shown in FIG. 1, the communication system 10 may include a terminal device 11 and a network device 12.

In an embodiment, the terminal device 11 may be a device that provides voice or data connectivity to a user. In some embodiments, the terminal device 11 may be referred to as user equipment (UE), a mobile station, a subscriber unit, a station, terminal equipment (TE), or the like. The terminal device 11 may be a cellular phone, a personal digital assistant (PDA), a wireless modem, a handheld device, a laptop computer, a cordless phone, a wireless local loop (WLL) station, a pad, or the like. With the development of wireless communication technologies, devices that can access a communication system, communicate with a network side of a communication system, or communicate with other devices through a communication system are terminal devices in the embodiments of the present disclosure, for example, terminal equipment and automobiles in smart transportation, household equipment in smart home, electric meter reading instruments, voltage monitoring instruments, and environment monitoring instruments in a smart power grid, or video monitoring instruments, and cash registers in a smart security network. In the embodiments of the present disclosure, a terminal device may communicate with a network device, and a plurality of terminal devices may communicate with each other. The terminal devices may be stationary or mobile.

In the embodiments of the present disclosure, the terminal device 11 may be a terminal device with normal functions, or be limited capability terminal equipment, for example, NR light terminal devices, RedCap terminal devices, or enhanced reduced capability terminal devices.

It should be noted that, in a 4G system, in order to support internet of things services, it is proposed two technologies: machine type communication (MTC) and narrow band internet of things (NB-IoT). The two technologies mainly aim at scenarios such as a low rate and high latency, for example, scenarios such as meter reading and environment monitoring. The NB-IoT currently can support only a maximum rate of several hundred kbps (kilobits per second), and the MTC currently can support only a maximum rate of several Mbps (megabits per second). However, with the continuous development of internet of things services, such as popularization of services such as video monitoring, smart home, wearable devices, and industry sensing monitoring, these services usually require a rate of tens to one hundred Mbps, and at the same time, have relatively high requirements for latency. Therefore, the MTC technology and the NB-IoT technology in the 4G system are difficult to meet the requirements. Based on this case, it is proposed to further design a new terminal device in 5G New Radio (NR) to cover the service requirements. In current 3rd generation partnership project (3GPP) standard, this new terminal device type is referred to as a limited capability terminal device (i.e., reduced capability UE, i.e., RedCap UE). Since the RedCap technology mainly aims at medium-rate application, a band width of the RedCap UE in a FRI frequency band of 5G is 20 MHz at maximum. In a new version of 3GPP standard, an applicable band width for RedCap is further reduced to 5 MHZ, and in this case, the terminal device may be referred to as an enhanced limited capability terminal device (i.e., enhanced reduced capability UE, i.e., eRedCap UE).

The network device 12 may be a device on an access network side configured to support a terminal device 11 to access the communication system. For example, the terminal device maybe an evolved NodeB (eNB) in a 4G access technology communication system, a next generation NodeB (gNB) in a 5G access technology communication system, a transmission reception point (TRP), a relay node, an access point (AP) or the like.

In the described communication system 10, the network device 12 may manage one or more cells, and one cell may include an integer number of terminal devices 11. In a cell, the network device 12 and the terminal device 11 may perform wireless communication by using radio resources. In a possible communication system, for example, in a 5G system, the radio resources may include a frequency domain resource. The frequency domain resource may be located within a preset frequency range, and the frequency range may be referred to as a frequency band. A center point of the frequency domain resource may be referred to as a center frequency point, and a width of the frequency domain resource may be referred to as a band width (BW).

When the network device 12 and the terminal device 11 perform wireless communication by using the frequency domain resource, the network device 12 manages a carrier frequency domain resource, and allocates the frequency domain resource to the terminal device 11 from the carrier frequency domain resource, so that the network device 12 and the terminal device 11 can perform communication by using the allocated frequency domain resource. The carrier frequency domain resource may be a system frequency domain resource, be a frequency domain resource that can be managed and allocated by the network device, or be a frequency domain resource that can be used for performing communication between the network device 12 and the terminal device 11.

Here, the carrier frequency domain resource may be a segment of continuous frequency domain resource, and in this case, the carrier frequency domain resource may be referred to as a carrier. A width of the carrier may be referred to as a system band width, a carrier band width, or a transmission band width. In the embodiments of the present disclosure, the frequency domain resource may be referred to as a frequency resource or other names, which is not specifically limited to the embodiments of the present disclosure.

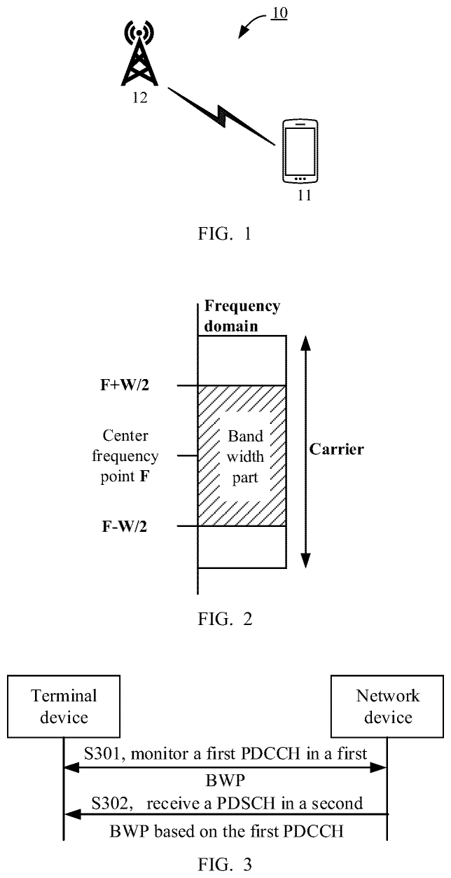

In some possible embodiments, a possible design in which the network device 12 allocates the frequency domain resource for the terminal device 11 is as follows: the network device configures a band width part (BWP) for the terminal device from the carrier, and the network device schedules the terminal device in the configured BWP. The design may also be described as follows: the network device configures a BWP for the terminal device from the carrier, and the network device may allocate some or all resources in the configured BWP to the terminal device for performing communication between the network device and the terminal device. The BWP configured by the network device for the terminal device is included in the carrier, and may be some continuous or discontinuous resources in the carrier, or be all resources in the carrier. The BWP may be referred to as a band width resource, a frequency domain resource part, a partial frequency domain resource, a frequency resource part, a partial frequency resource, a carrier BWP, or other names, which is not specifically limited to the embodiments of the present disclosure. When the BWP is a segment of continuous resource in the carrier, the BWP may be referred to as a sub-band, a narrow band, or other names, which is not specifically limited to the embodiments of the present disclosure. In some examples, FIG. 2 is a schematic diagram of a BWP according to an embodiment of the present disclosure. Referring to the FIG. 2, the BWP is a segment of a continuous resource in a carrier, where a band width of the BWP is W, a center frequency point of the BWP is F, which may also be described as follows: a frequency of a highest frequency point in the BWP is F+2/W, and a frequency of a lowest frequency point in the BWP is F−W/2.

In an NR technology, a PDCCH for scheduling an SIB (for example, an SIB1) is transmitted in a CORESET0, and a PDSCH for carrying the SIB is transmitted within a frequency range corresponding to the CORESET0. Here, the term “carrying” may also be described as “bearing”.

However, for the limited capability terminal devices, a band width of the CORESET0 will exceed a band width of these terminal devices, and in this case, it is difficult to monitor the PDCCH, so that the PDSCH carrying the SIB cannot be scheduled.

It should be noted that, in the embodiments of the present disclosure, the band width of the terminal device may be understood as a band width capability of the terminal device, or be described as a band width supported by the terminal device. The band width of the terminal device may include a downlink band width of the terminal device, or be described as a receiving band width, a downlink receiving band width, etc. of the terminal device, that is, a band width supported by the terminal device during receiving. In some possible embodiments, the band width of the terminal device may further include an uplink band width of the terminal device, or be described as a sending band width, an uplink sending band width, etc. of the terminal device, that is, a band width supported by the terminal device during sending. The receiving band width of the terminal device and the sending band width of the terminal device may be same or different, which is not limited to the embodiments of the present disclosure.

The present disclosure provides data transmission methods, communication apparatuses and communication equipment, so as to implement PDSCH scheduling across band width parts.

In order to solve the problem, the present disclosure provides a data transmission method, and the method may be performed by a terminal device in the communication system.

FIG. 3 is a schematic flowchart of implementing a data transmission method on a terminal device side according to an embodiment of the present disclosure. Referring to FIG. 3, the method may include S301 to S302.

At S301, a terminal device monitors a first PDCCH in a first BWP.

A band width of the first PDCCH is located in a receiving band width of the terminal device, and the first PDCCH is used to schedule a PDSCH.

It may be understood that, when the terminal device randomly accesses a network device, the terminal device may monitor the first PDCCH in the first BWP according to an indication such as a master information block (MIB), higher layer signaling, or predefinition.

Here, the higher layer signaling may be radio resource control (RRC) signaling, a broadcast message, a system message, a medium access control (MAC) control element (CE), DCI, or signaling carried by the PDSCH.

It should be noted that, since the band width of the first PDCCH is located in the receiving band width of the terminal device, the terminal device may receive the first PDCCH once monitoring the first PDCCH in the first BWP. Then, the terminal device parses the first PDCCH to obtain control information contents carried in the first PDCCH, for example, contents of each information field in downlink control information (DCI). In some examples, the DCI carried in the first PDCCH may include scheduling information of the PDSCH.

At S302, the terminal device receives a PDSCH in a second BWP based on the first PDCCH.

It may be understood that the terminal device, after monitoring the first PDCCH and receiving the first PDCCH, may parse the first PDCCH to obtain the scheduling information of the PDSCH in the first PDCCH. Then, the terminal device receives the PDSCH in the second BWP according to the scheduling information of the PDSCH. In this way, it is implemented that the PDSCH in the second BWP is scheduled by using the PDCCH in the first BWP, that is, the PDSCH is scheduled across BWPs.

In some examples, the first BWP may be a dedicated BWP or a default BWP of the terminal device. The second BWP may be an initial BWP of the terminal device, and is used to carry an SIB; or the second BWP may be a dedicated BWP of the terminal device.

In some possible embodiments, the PDSCH carries an SIB. In some examples, the PDSCH carries an SIB1.

In some possible embodiments, a band width of the second BWP is greater than the receiving band width of the terminal device.

In some examples, the second BWP corresponds to a frequency domain resource of a CORESET0, which may be described as that the band width of the second BWP includes a frequency domain band width occupied by the CORESET0.

In some possible embodiments, the first BWP may be used for transmitting only the first PDCCH used to schedule the PDSCH in the second BWP; and the second BWP may be used for transmitting only the PDSCH scheduled by the first PDCCH, or transmitting other PDCCHs, where the PDCCHs may be used by other terminal devices (for example, a terminal device with a different capability) to schedule the PDSCH in the second BWP, or be used to schedule other PDSCHs in other BWPs.

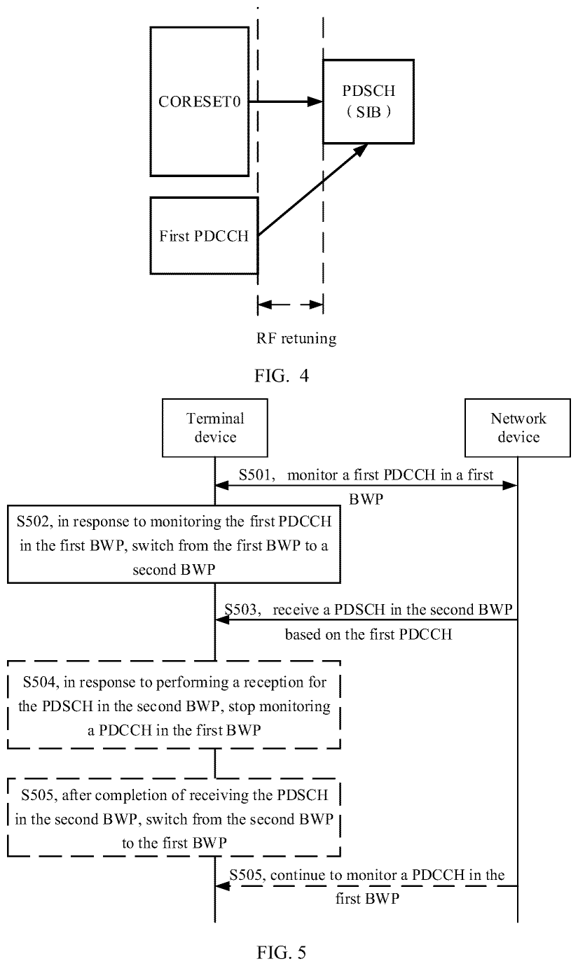

FIG. 4 is a schematic diagram of a frequency domain resource according to an embodiment of the present disclosure. Referring to FIG. 4, the network device may further send a second PDCCH to some non-limited capability terminal devices in the second BWP, and the second PDCCH may schedule the PDSCH in the second BWP. In some examples, a frequency domain resource occupied by the second PDCCH may be included in a frequency domain resource occupied by the second BWP. Further, the frequency domain resource occupied by the second PDCCH may be located in the CORESET0 in the second BWP, and a band width of the second PDCCH may be less than or equal to the frequency domain band width occupied by the CORESET0 in the second BWP. It can be learned that the second PDCCH located in the CORESET0 in the second BWP and the first PDCCH in the first BWP may schedule the same PDSCH.

In some possible embodiments, a band width of the first BWP is less than the receiving band width of the terminal device.

In an embodiment, for a limited capability terminal device such as eRedCap UE, the band width of the second BWP will be greater than the receiving band width of the terminal device, so that, if the terminal device monitors the PDCCH in the second BWP, there is a possibility that the PDCCH cannot be monitored, and then the PDSCH cannot be scheduled. Therefore, in order to enable the terminal device to schedule the PDSCH to obtain an SIB, the band width of the first BWP is less than the receiving band width of the terminal device.

In some possible embodiments, since the band width of the first PDCCH is located in the receiving band width of the terminal device, the terminal device may monitor the first PDCCH in the first BWP. In response to the terminal device monitoring the first PDCCH in the first BWP, the method may further include: the terminal device may parse the first PDCCH to obtain control information contents included in the first PDCCH based on configuration information of the second BWP.

It may be understood that the first PDCCH is used to schedule the PDSCH, and a frequency domain resource occupied by the PDSCH (that is, the second BWP) is associated with transmission contents of the first PDCCH (which may be described as the control information contents included in the first PDCCH). Therefore, the network device may generate the transmission contents of the first PDCCH according to the configuration information of the second BWP, so that the terminal device can receive the PDSCH based on the first PDCCH, and further parse the SIB in the PDSCH. In some examples, the configuration information of the second BWP may include the band width, subcarrier spacing, etc. of the second BWP.

In the embodiments of the present disclosure, the terminal device monitors, in the first BWP, the first PDCCH whose band width is located in the receiving band width of the terminal device. Since the first PDCCH is used to schedule the PDSCH, the terminal device can receive the PDSCH in the second BWP based on the first PDCCH. In this way, it is implemented that the terminal device schedules the PDSCH across BWPs.

In some possible embodiments, the embodiments of the present disclosure further provide another data transmission method, and the method may still be performed by a terminal device in a communication system.

FIG. 5 is a schematic flowchart of implementing another data transmission method on a terminal device side according to an embodiment of the present disclosure. Referring to solid lines in FIG. 5, the method may include S501 to S503.

At S501, a terminal device monitors a first PDCCH in a first BWP.

At S502, in response to the terminal device monitoring the first PDCCH in the first BWP, the terminal device switches from the first BWP to a second BWP.

It may be understood that, for a terminal device configured with multiple BWPs, only one BWP may be in an activated state at a time, and in this case, the BWP may be referred to as an activated BWP. Therefore, in S501, the activated BWP is the first BWP. The terminal device, after monitoring the first PDCCH in the first BWP, switches from the first BWP to the second BWP, that is, activates the second BWP, and then performs S503: receiving a PDSCH in the second BWP.

In practical applications, switching latency (which is described as switching latency A, first switching latency, or the like) may be predefined, where the switching latency is a duration for the terminal device switching from the first BWP to the second BWP. The terminal device, after parsing the first PDCCH and obtaining control information contents in the first PDCCH, determines the switching latency, and performs RF retuning or BWP switching. Then, within the switching latency A, the terminal device switches from the first BWP to the second BWP.

In some examples, the switching latency A may be X (X is a positive integer) time units, and a time unit may be a slot, a sub-slot, a symbol, or the like.

In some examples, in the process of switching from the first BWP to the second BWP, that is, within the switching latency A, the terminal device stops monitoring downlink information in the first BWP, for example, downlink control information (DCI), or a channel state information reference signal (CSI-RS).

Further, the first PDCCH may further carry scheduling latency of the PDSCH, so as to instruct the terminal device to schedule the PDSCH by delaying Y time units (that is, the scheduling latency).

In some examples, the scheduling latency is greater than or equal to the switching latency A, that is, the Y is a positive integer greater than or equal to X. In this way, the terminal device, after switching from the first BWP to the second BWP, can receive the PDSCH, which improves the reliability of PDSCH scheduling.

At S503, the terminal device receives a PDSCH in the second BWP based on the first PDCCH.

It should be noted that, for specific implementation processes of S501 and S503, reference may be made to the description of S301 and S302 in FIG. 3, which will not be described herein again.

In some possible embodiments, referring to dotted lines in FIG. 5, after S503, the method may further include S504.

At S504, in response to the terminal device performing a reception for the PDSCH in the second BWP, the terminal device stops monitoring a PDCCH in the first BWP. It may be understood that, in the process of the terminal device performing a reception for the PDSCH in the second BWP, the first BWP is deactivated, and in this case, the terminal device stops monitoring a PDCCH in the first BWP.

In some possible embodiments, still referring to the dotted lines in FIG. 5, after S503, the method may further include S505.

At S505, the terminal device, after completion of receiving the PDSCH in the second BWP or after receiving the PDSCH on M (M is a positive integer) time units in the second BWP, switches from the second BWP to the first BWP, and continues to monitor a PDCCH in the first BWP. The M time units may be predefined or configured by a network device, and of course, be determined in other manners, which is not specifically limited to the embodiments of the present disclosure.

In some possible embodiments, another switching latency (which is described as switching latency B, second switching latency, or the like) may be predefined, where the another switching latency is, a duration for the terminal device switching from the second BWP to the first BWP. The terminal device, after completion of receiving the PDSCH in the second BWP or after receiving the PDSCH on M time units in the second BWP, determines the switching latency B, and performs RF retuning or BWP switching. Then, within the switching latency B, the terminal device switches from the second BWP back to the first BWP.

In practical applications, the switching latency B may be equal to the switching latency A, that is, the switching latency B is X time units, or be unequal to the switching latency A, which is not specifically limited to the embodiments of the present disclosure.

It may be understood that, in order to reduce device power consumption, the terminal device, after completion of receiving the PDSCH in a BWP with a larger band width, may switch back to a BWP with a smaller band width. For example, the terminal device, after completion of receiving the PDSCH in the second BWP (for example, a BWP with a larger band width), switches from the second BWP back to the first BWP (for example, a BWP with a smaller band width), and continues to monitor a PDCCH in the first BWP. In this case, the second BWP is deactivated, and the first BWP is activated.

In the embodiments of the present disclosure, the terminal device monitors, in the first BWP, the first PDCCH whose band width is located in the receiving band width of the terminal device. Since the first PDCCH is used to schedule the PDSCH, the terminal device can receive the PDSCH in the second BWP based on the first PDCCH. In this way, it is implemented that the terminal device schedules the PDSCH across BWPs. Further, the terminal device may switch from the first BWP to the second BWP to receive the PDSCH, and after completion of receiving, switch back to the first BWP, so as to save device power consumption.

Based on the same inventive concept, the embodiments of the present disclosure further provide a data transmission method, which may be performed by a network device in the communication system.

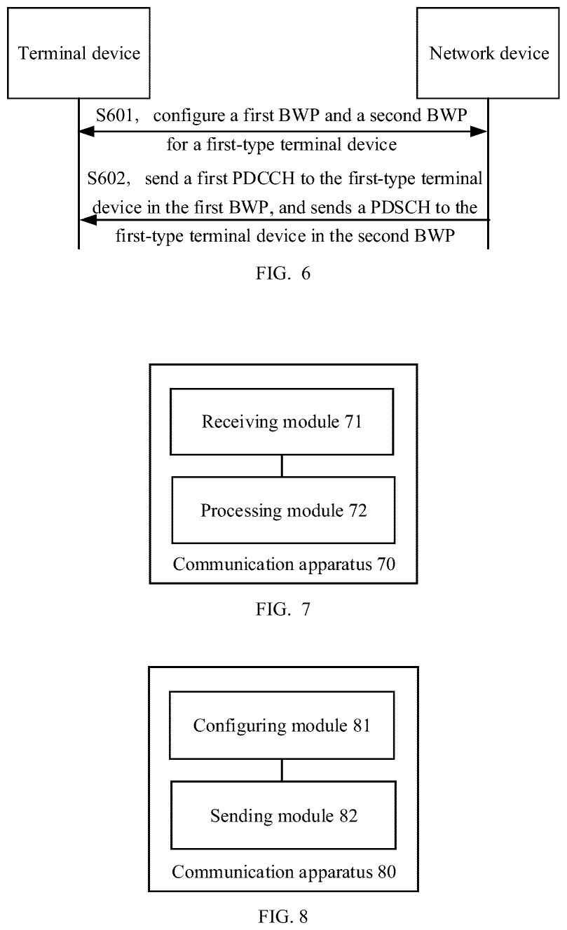

FIG. 6 is a flowchart of implementing a data transmission method on a network device side according to an embodiment of the present disclosure. Referring to FIG. 6, the method may include S601 to S602.

At S601, a network device configures a first BWP and a second BWP for a first-type terminal device.

In some examples, the first-type terminal device may be a limited capability terminal device, for example, NR light UE, RedCap UE, or eRedCap UE.

It may be understood that the network device may determine BWPs with different band widths for the first-type terminal device, and indicate these BWPs to the first-type terminal device. Specifically, the network device may indicate configuration information of the first BWP and configuration information of the second BWP by using a master information block (MIB), higher layer signaling, predefinition, etc. Here, the higher layer signaling may be RRC signaling, a broadcast message, a system message, an MAC CE, DCI, or signaling carried by a PDSCH.

In some examples, the first BWP may be configured as a dedicated BWP or a default BWP of the terminal device. The second BWP may be configured as an initial BWP of the terminal device, and is used to carry an SIB; or the second BWP may be a dedicated BWP of the terminal device.

In some possible embodiments, a band width of the second BWP is greater than a receiving band width of the first-type terminal device.

In some possible embodiments, the second BWP corresponds to a frequency domain resource of a CORESET0, which may be described as that the band width of the second BWP includes a frequency domain band width occupied by the CORESET0.

In some possible embodiments, a band width of the first BWP is less than the receiving band width of the first-type terminal device.

In some possible embodiments, the first BWP may be used for transmitting only the first PDCCH used to schedule the PDSCH in the second BWP; and the second BWP may be used for transmitting only the PDSCH scheduled by the first PDCCH, or transmitting other PDCCHs. The PDCCHs may be used by a second-type terminal device to schedule the PDSCH in the second BWP, or be used by a second-type terminal device to schedule other PSDCHs in other BWPs.

In some examples, still referring to FIG. 4, the network device may further send a second PDCCH to the second-type terminal device in the second BWP, and the second PDCCH may schedule the PDSCH in the second BWP. In some examples, a frequency domain resource occupied by the second PDCCH may be included in a frequency domain resource occupied by the second BWP. Further, the frequency domain resource occupied by the second PDCCH may be located in the CORESET0 in the second BWP, and a band width of the second PDCCH may be less than or equal to a frequency domain band width occupied by the CORESET0 in the second BWP. It can be learned that the second PDCCH located in the CORESET0 in the second BWP and the first PDCCH in the first BWP may schedule the same PDSCH.

In the embodiments of the present disclosure, a capability of the first-type terminal device is different from a capability of the second-type terminal device. For example, the first-type terminal device may be a limited capability terminal device, and the second-type terminal device is a terminal device with a normal function; or the first-type terminal device may be eRedCap UE, and the second-type terminal device may be NR light UE or eRedCap UE.

At S602, the network device sends a first PDCCH to the first-type terminal device in the first BWP, and sends a PDSCH to the first-type terminal device in the second BWP.

Here, the first PDCCH is used to schedule the PDSCH, and a band width of the first PDCCH is located in a receiving band width of the first-type terminal device.

In some possible embodiments, the PDSCH carries an SIB, and in some examples, the PDSCH carries an SIB1.

In some possible embodiments, before S602, the method may further include: the network device generates control information contents included in the first PDCCH based on configuration information of the second BWP.

It may be understood that the first PDCCH is used to schedule the PDSCH, and a frequency domain resource occupied by the PDSCH (that is, the second BWP) is associated with transmission contents of the first PDCCH (which may be described as the control information contents included in the first PDCCH). Therefore, the network device may generate the transmission contents of the first PDCCH according to the configuration information of the second BWP, so that the terminal device can receive the PDSCH based on the first PDCCH, and further parse the SIB in the PDSCH. In some examples, the configuration information of the second BWP may include the band width, subcarrier spacing, etc. of the second BWP.

In some possible embodiments, the method further includes: the network device indicates scheduling latency of the PDSCH. The scheduling latency may be carried in the first PDCCH (which may be described as that the first PDCCH includes the scheduling latency), and the scheduling latency is greater than or equal to switching latency of the first-type terminal device. The scheduling latency is a duration for the first-type terminal device delaying to schedule the PDSCH, and the switching latency is a duration for the first-type terminal device switching from the first BWP to the second BWP.

It may be understood that switching latency A (for example, X time units) may be predefined, that is, a duration for the terminal device switching from the first BWP to the second BWP. The network device may determine the scheduling latency (for example, Y time units) according to the switching latency A, so as to instruct the first-type terminal device to schedule the PDSCH by delaying Y time units. In some examples, Y is a positive integer greater than or equal to X. In this way, the terminal device, after switching from the first BWP to the second BWP, can immediately receive the PDSCH, which improves PDSCH scheduling efficiency and reduces device power consumption.

In some possible embodiments, in response to the first-type terminal device switching from the first BWP to the second BWP, the method may further include: the network device stops sending downlink information, for example, DCI or a CSI-RS, to the first-type terminal device within the switching latency A.

Further, the first PDCCH may further carry scheduling latency of the PDSCH, so as to instruct the terminal device to schedule the PDSCH by delaying Y time units (that is, the scheduling latency).

In some possible embodiments, in response to the first-type terminal device performing a reception for the PDSCH in the second BWP, the method may further include: the network device stops sending a PDCCH to the first-type terminal device in the first BWP.

It may be understood that, in the process of the terminal device performing a reception for the PDSCH in the second BWP, the first BWP is deactivated, and in this case, the network device stops sending a PDCCH in the first BWP.

In some possible embodiments, in response to the terminal device completing receiving the PDSCH in the second BWP, the method further includes: the network device determines a timing at which the first-type terminal device switches from the second BWP to the first BWP, and after the timing, the network device sends a PDCCH to the first-type terminal device in the first BWP.

It may be understood that, in order to reduce device power consumption, the terminal device, after completion of receiving the PDSCH in the second BWP or after receiving the PDSCH on M (M is a positive integer) time units in the second BWP, switches from the second BWP to the first BWP, and continues to monitor a PDCCH in the first BWP. Correspondingly, after the first-type terminal device switches from the second BWP back to the first BWP, the network device continues to send a PDCCH to the first-type terminal device. The M time units may be predefined or configured by the network device, and of course, be determined in other manner, which is not specifically limited to the embodiments of the present disclosure.

It should be noted that, for specific description of the first BWP and the second BWP, reference may be made to the description of the first BWP and the second BWP in FIG. 3 to FIG. 5, which will not be described herein again. In addition, for specific description of the data transmission method on the first-type terminal device side, reference may be made to the description of the data transmission method on the terminal device side in FIG. 3 to FIG. 5.

In the embodiments of the present disclosure, the network device sends, in the first BWP, the first PDCCH whose band width is located in the receiving band width of the network device to the first-type terminal device, and sends the PDSCH scheduled by the first PDCCH in the second BWP, so that the terminal device, after monitoring the first PDCCH in the first BWP, can receive the PDSCH in the second BWP based on the first PDCCH. In this way, the terminal device can schedule the PDSCH across BWPs.

Based on the same inventive concept, the embodiments of the present disclosure further provide a communication apparatus. The communication apparatus may be a terminal device in a communication system, a chip in a terminal device, or a system on chip, or be a functional module that is configured to implement the methods in the above embodiments in a terminal device. The communication apparatus may implement the functions performed by the terminal device in the above embodiments, and these functions may be implemented by hardware executing corresponding software. The hardware or software includes one or more modules corresponding to the functions. FIG. 7 is a structural schematic diagram of a communication apparatus 70 according to an embodiment of the present disclosure. Referring to FIG. 7, the communication apparatus 70 includes a receiving module 71, configured to monitor a first physical downlink control channel PDCCH in a first BWP, and receive a physical downlink shared channel PDSCH in a second BWP based on the first PDCCH, where a bandwidth of the first PDCCH is located in a receiving bandwidth of a terminal device, and the first PDCCH is used to schedule the PDSCH.

In some possible embodiments, as shown in FIG. 7, the apparatus 70 further includes a processing module 72, configured to parse the first PDCCH and obtain control information contents included in the first PDCCH based on configuration information of the second BWP.

In some possible embodiments, the PDSCH carries a system message.

In some possible embodiments, a band width of the second BWP is greater than the receiving band width of the terminal device.

In some possible embodiments, the second BWP corresponds to a frequency domain resource of a CORESET0.

In some possible embodiments, a band width of the first BWP is less than the receiving band width of the terminal device.

In some possible embodiments, the receiving module 71 is further configured to, in response to monitoring the first PDCCH in the first BWP, switch from the first BWP to the second BWP, and receive the PDSCH in the second BWP.

In some possible embodiments, the receiving module 71 is further configured to determine switching latency, and stop monitoring downlink information within the switching latency. It may be understood that the switching latency is a duration for the terminal device switching from the first BWP to the second BWP.

In some possible embodiments, the first PDCCH further carries scheduling latency of the PDSCH, and the scheduling latency is greater than or equal to the switching latency. It may be understood that the scheduling latency is a duration for the terminal device delaying to schedule the PDSCH.

In some possible embodiments, the receiving module 71 is further configured to, in response to receiving the PDSCH in the second BWP, stop monitoring the first PDCCH in the first BWP.

In some possible embodiments, the receiving module 71 is further configured to, in response to completion of receiving the PDSCH in the second BWP or in response to receiving the PDSCH on M time units in the second BWP, switch from the second BWP to the first BWP, and continue to monitor a PDCCH in the first BWP, where M is a positive integer.

It should be noted that, for specific implementation processes of the receiving module 71 and the processing module 72, reference may be made to the detailed description of the embodiments in FIG. 3 to FIG. 5, which, for brevity of the specification, will not be described herein again.

The receiving module 71 mentioned in the embodiments of the present disclosure may be a receiving interface, a receiving circuit, a receiver, or the like; and the processing module 72 may be one or more processors.

Based on the same inventive concept, the embodiments of the present disclosure further provide a communication apparatus. The communication apparatus may be a network device in a communication system, a chip in a network device, or a system on chip, or be a functional module that is configured to implement the methods in the above embodiments in a terminal device. The communication apparatus may implement the functions performed by the terminal device in the above embodiments, and these functions may be implemented by hardware executing corresponding software. The hardware or software includes one or more modules corresponding to the functions. FIG. 8 is a structural schematic diagram of another communication apparatus 80 according to an embodiment of the present disclosure. Referring to FIG. 8, the communication apparatus 80 includes a configuring module 81, configured to configure a first BWP and a second BWP for a first-type terminal device, where the first BWP is used to send a first physical downlink control channel PDCCH to the first-type terminal device, the second BWP is used to send a first physical downlink shared channel PDSCH to the first-type terminal device, the first PDCCH is used to schedule the PDSCH, and a band width of the first PDCCH is located in a receiving band width of the first-type terminal device.

In some possible embodiments, the configuring module 81 is further configured to generate control information contents included in the first PDCCH based on configuration information of the second BWP.

In some possible embodiments, as shown in FIG. 8, the apparatus 80 further includes a sending module 82, configured to send a second PDCCH to a second-type terminal device in the second BWP, where the second PDCCH is used to schedule the PDSCH, and a capability of the second-type terminal device is different from a capability of the first-type terminal device.

In some possible embodiments, the PDSCH carries a system message.

In some possible embodiments, a band width of the second BWP is greater than the receiving band width of the first-type terminal device.

In some possible embodiments, the second BWP corresponds to a frequency domain resource of a CORESET0.

In some possible embodiments, a band width of the first BWP is less than the receiving band width of the first-type terminal device.

In some possible embodiments, the sending module 82 is further configured to indicate scheduling latency of the PDSCH, where the first PDCCH includes the scheduling latency, and the scheduling latency is greater than or equal to switching latency of the first-type terminal device.

It may be understood that the scheduling latency is a duration for the first-type terminal device delaying to schedule the PDSCH, and the switching latency is a duration for the first-type terminal device switching from the first BWP to the second BWP.

In some possible embodiments, the sending module 82 is further configured to stop sending downlink information to the first-type terminal device within the switching latency.

In some possible embodiments, the sending module 82 is further configured to, in response to the first-type terminal device receiving the PDSCH in the second BWP, stop sending a PDCCH to the first-type terminal device in the first BWP.

In some possible embodiments, the sending module 82 is further configured to determine a timing at which the first-type terminal device switches from the second BWP to the first BWP, and after the timing, send a PDCCH to the first-type terminal device in the first BWP.

It should be noted that, for specific implementation processes of the configuring module 81 and the sending module 82, reference may be made to the detailed description of the embodiment in FIG. 6, which, for brevity of the specification, will not be described herein again.

The sending module 82 mentioned in the embodiments of the present disclosure may be a receiving interface, a receiving circuit, a receiver, or the like; and the configuring module 81 may be one or more processors.

According to a fifth aspect of the present disclosure, there is provided communication equipment, for example, a terminal device, including: an antenna; a memory; a processor, respectively connected to the antenna and the memory, and configured to execute computer executable instructions stored in the memory, control reception and transmission of the antenna, and implement the data transmission method according to the first aspect of the present disclosure and any one of its possible embodiments.

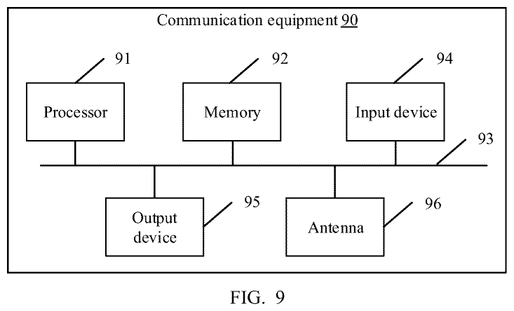

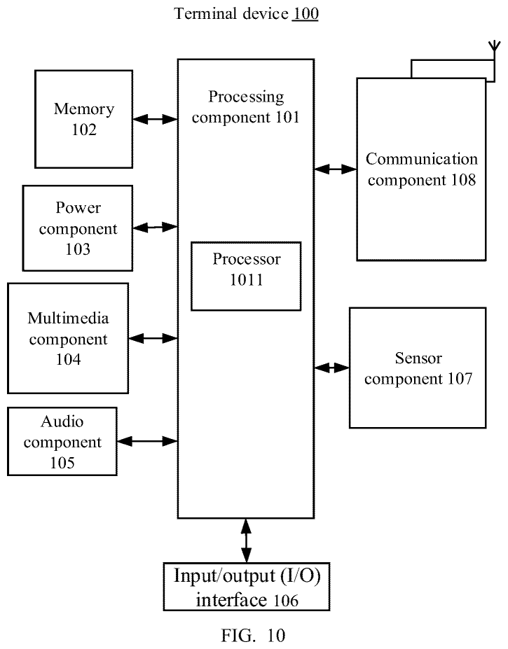

Based on the same inventive concept, the embodiments of the present disclosure provide communication equipment, and the communication equipment may be the terminal device or the network device in one or more of the above embodiments. FIG. 9 is a structural schematic diagram of communication equipment according to an embodiment of the present disclosure. Referring to FIG. 9, the communication equipment 90 uses general-purpose computer hardware, and includes a processor 91, a memory 92, a bus 93, an input device 94, an output device 95, and antenna 96.

In some possible embodiments, the memory 92 may include a computer storage medium in the form of volatile and/or non-volatile memory, such as a read only memory and/or a random access memory. The memory 92 may store an operating system, application programs, other program modules, executable codes, program data, user data, and the like.

The input device 94 may be used to input commands and information to the communication equipment, and the input device 94 is, for example, a keyboard or a pointing device, such as a mouse, a trackball, a touchpad, a microphone, a joystick, a game pad, a satellite television antenna, a scanner, or similar device. These input devices may be connected to the processor 91 through the bus 93.

The output device 95 may be used by the communication equipment to output information. In addition to a monitor, the output device 95 may be other peripheral output device, for example, a speaker and/or a printing device, and these output devices may be connected to the processor 91 through the bus 93.

The communication equipment may be connected to a network, for example, a local area network (LAN), through the antenna 96. In a networked environment, computer executable instructions stored in a control device may be stored in a remote storage device, and are not limited to being stored locally.

When the processor 91 in the communication equipment executes the executable codes or the application programs stored in the memory 92, the communication equipment performs the communication method on the terminal device side or the network device side in the above embodiments. For specific implementation processes, reference may be made to the above embodiments, which will not be described herein again.

In addition, the memory 92 stores computer executable instructions for implementing functions of the receiving module 71 and the processing module 72 in FIG. 7. Functions/implementation processes of the receiving module 71 and the processing module 72 in FIG. 7 may be implemented by the processor 91 in FIG. 9 calling the computer executable instructions stored in the memory 92. For specific implementation processes and functions, reference may be made to the above relevant embodiments.

In some examples, the memory 92 stores computer executable instructions for implementing functions of the configuring module 81 and the sending module 82 in FIG. 8. Functions/implementation processes of the configuring module 81 and the sending module 82 in FIG. 8 may be implemented by the processor 91 in FIG. 9 calling the computer executable instructions stored in the memory 92. For specific implementation processes and functions, reference may be made to the included relevant embodiments.

Based on the same inventive concept, the embodiments of the present disclosure provide a terminal device, and the terminal device is consistent with the terminal device in one or more of the above embodiments. In some examples, the terminal device may be a mobile phone, a computer, a digital broadcast terminal device, a messaging device, a game console, a tablet device, medical equipment, fitness equipment, a personal digital assistant, or the like.

FIG. 10 is a structural schematic diagram of a terminal device according to an embodiment of the present disclosure. As shown in FIG. 10, the terminal device 100 may include one or more of the following components a processing component 101, a memory 102, a power component 103, a multimedia component 104, an audio component 105, an input/output (I/O) interface 106, a sensor component 107, and a communication component 108.

The processing component 101 usually controls the overall operation of the terminal device 100, such as operations associated with display, telephone calls, data communications, camera operations, and recording operations. The processing component 101 may include one or more processors 1011 to execute instructions to perform all or part of the steps in the methods described above. Moreover, the processing component 101 may include one or more modules to facilitate interaction between the processing component 101 and other components. For example, the processing component 101 may include a multimedia module to facilitate interaction between the multimedia component 104 and the processing component 101.

The memory 102 is configured to store various types of data to support operation at the terminal device 100. Examples of these data include instructions for any application or method operating at the terminal device 100, contact data, phone book data, messages, pictures, videos, and the like. The memory 102 may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 103 provides power to various components of the terminal device 100. The power component 103 may include a power management system, one or more power sources, and other components associated with power generated, managed, and distributed for the terminal device 100.

The multimedia component 104 includes a screen that provides an output interface between the terminal device 100 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 104 includes a front camera and/or a rear camera. When the terminal device 100 is in an operation mode, such as a shooting mode or a video mode, the front camera and/or the rear camera may receive external multimedia data. Each of the front and rear cameras may be a fixed optical lens system or have a focal length and an optical zoom capability.

The audio component 105 is configured to output and/or input audio signals. For example, the audio component 105 includes a microphone (MIC) configured to receive an external audio signal when the terminal device 100 is in an operation mode, such as a call mode, a recording mode, and a voice recognition mode. The received audio signal may be further stored in the memory 102 or transmitted via the communication component 108. In some examples, the audio component 105 also includes a loudspeaker for outputting an audio signal.

The I/O interface 106 provides an interface between the processing component 101 and a peripheral interface module which may be a keyboard, a click wheel, a button, or the like. These buttons may include, but are not limited to a home button, a volume button, a start button, and a lock button.

The sensor component 107 includes one or more sensors for providing a status assessment in various aspects to the terminal device 100. For example, the sensor component 107 may detect an open/closed state of the terminal device 100, and the relative positioning of components, for example, the component is a display and a keypad of the terminal device 100. The sensor component 107 may also detect a change in position of the terminal device 100 or a component of the terminal device 100, the presence or absence of a user in contact with the terminal device 100, the orientation or acceleration/deceleration of the terminal device 100 and a change in temperature of the terminal device 100. The sensor component 107 may include a proximity sensor configured to detect the presence of nearby objects without any physical contact. The sensor component 107 may also include a light sensor, such as a CMOS or CCD image sensor, for use in imaging applications. In some examples, the sensor component 107 may also include an acceleration sensor, a gyro sensor, a magnetic sensor, a pressure sensor, or a temperature sensor.

The communication component 108 is configured to facilitate wired or wireless communication between the terminal device 100 and other devices. The terminal device 100 may access a wireless network based on a communication standard, such as WiFi, 2G, 3G, 4G or 5G, or a combination thereof. In an example, the communication component 108 receives broadcast signals or broadcast associated information from an external broadcast management system via a broadcast channel. In an example, the communication component 108 also includes a near field communication (NFC) module to facilitate short range communication. For example, the NFC module may be implemented based on a radio frequency identification (RFID) technology, an infrared data association (IrDA) technology, an ultra wide band (UWB) technology, a Bluetooth (BT) technology, and other technologies.

In an example, the terminal device 100 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above methods.

Based on the same inventive concept, the embodiments of the present disclosure provide a network device, and the network device is consistent with the network device in one or more of the above embodiments.

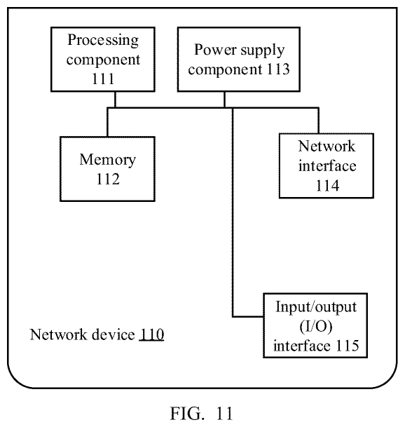

FIG. 11 is a structural schematic diagram of a network device according to an embodiment of the present disclosure. As shown in FIG. 11, the network device 110 may include a processing component 111, which includes one or more processors (not shown); and a memory resource represented by a memory 112 for storing instructions executable by the processing component 111, such as application programs. The application programs stored in the memory 112 may include one or more modules, each corresponding to a set of instructions. Furthermore, the processing component 111 is configured to execute the instructions to implement any of the methods performed by the network device.

The network device 110 may further include a power supply component 113 configured to perform power management on the network device 110; a wired or wireless network interface 114 configured to connect the network device 110 to a network; and an input/output (I/O) interface 115. The network device 110 may operate an operating system stored in the memory 112, such as Windows Server™, Mac OS X™, Unix™, Linux™, or FreeBSD™.

Based on the same inventive concept, the embodiments of the present disclosure further provide a non-transitory computer readable storage medium, where the non-transitory computer readable storage medium stores instructions; and the instructions are running on a computer to perform the communication method on the terminal device side or the network device side in one or more of the embodiments described herein.

Based on the same inventive concept, the embodiments of the present disclosure further provide a computer program or a computer program product, and the computer program product is executed on a computer to cause the computer to implement the communication method on the terminal device side or the network device side in one or more of the embodiments described herein.

Other embodiments of the present invention will be readily apparent to those skilled in the art after considering the specification and practicing the invention disclosed herein. The present disclosure is intended to cover any variations, uses, or adaptations of the present invention, which follow the general principle of the present invention and include common knowledge or conventional technical means in the art that are not disclosed in the present disclosure. The specification and examples are to be regarded as illustrative only. The true scope and spirit of the present invention are pointed out by the following claims.

It is to be understood that the present invention is not limited to the precise structures that have described and shown in the drawings, and various modifications and changes can be made without departing from the scope thereof. The scope of the invention is to be limited only by the appended claims.

1. A data transmission method, comprising:
monitoring, by a terminal device, a first physical downlink control channel (PDCCH) in a first band width part, and receiving a physical downlink shared channel (PDSCH) in a second band width part based on the first PDCCH, wherein a band width of the first PDCCH is located in a receiving band width of the terminal device, and the first PDCCH is used for scheduling the PDSCH.

2. The data transmission method according to claim 1, further comprising:
in response to the first PDCCH having been monitored by the terminal device in the first band width part, parsing, by the terminal device, the first PDCCH and obtaining control information contents comprised in the first PDCCH based on configuration information of the second band width part.

3. The data transmission method according to claim 1, wherein the PDSCH carries a system message.

4. The data transmission method according to claim 1, further comprising at least one of:
a band width of the second band width part being greater than the receiving band width of the terminal device;
the second band width part corresponding to a frequency domain resource of a control resource set (CORESET) 0; or
a band width of the first band width part being less than the receiving band width of the terminal device.

5-6. (canceled)

7. The data transmission method according to claim 1, further comprising:
in response to the first PDCCH having been monitored by the terminal device in the first band width part, switching, by the terminal device, from the first band width part to the second band width part, and receiving the PDSCH in the second band width part.

8. The data transmission method according to claim 7, further comprising:
determining, by the terminal device, switching latency; and
stopping, by the terminal device, monitoring downlink information within the switching latency.

9. The data transmission method according to claim 8, wherein the first PDCCH further carries scheduling latency of the PDSCH, and the scheduling latency is greater than or equal to the switching latency.

10. The data transmission method according to claim 1, further comprising:
in response to the terminal device performing a reception for the PDSCH in the second band width part, stopping, by the terminal device, monitoring the first PDCCH in the first band width part.

11. The data transmission method according to claim 1, further comprising:
in response to completion of receiving the PDSCH in the second band width part or in response to receiving the PDSCH on M time units in the second band width part, switching, by the terminal device, from the second band width part to the first band width part, and continuing to monitor a PDCCH in the first band width part, wherein the M is a positive integer.

12. The data transmission method according to claim 1, wherein the terminal device is an enhanced reduced capability (eRedCap) terminal device.

13. A data transmission method, comprising:
configuring, by a network device, a first band width part and a second band width part for a first-type terminal device, wherein the first band width part is used for sending a first physical downlink control channel (PDCCH) to the first-type terminal device, the second band width part is used for sending a first physical downlink shared channel (PDSCH) to the first-type terminal device, the first PDCCH is used for scheduling the PDSCH, and a band width of the first PDCCH is located in a receiving band width of the first-type terminal device.

14. The data transmission method according to claim 13, further comprising:
generating, by the network device, control information contents comprised in the first PDCCH based on configuration information of the second band width part.

15. The data transmission method according to claim 13, further comprising:
sending, by the network device, a second PDCCH to a second-type terminal device in the second band width part, wherein the second PDCCH is used for scheduling the PDSCH, and a capability of the second-type terminal device is different from a capability of the first-type terminal device.

16. The data transmission method according to claim 13, wherein the PDSCH carries a system message.

17. The data transmission method according to claim 13, further comprising at least one of:
a band width of the second band width part being greater than the receiving band width of the first-type terminal device;
the second band width part corresponding to a frequency domain resource of a control resource set (CORESET) 0; or
a band width of the first band width part being less than the receiving band width of the first-type terminal device.

18-19. (canceled)

20. The data transmission method according to claim 13, further comprising:
indicating, by the network device, scheduling latency of the PDSCH, wherein the first PDCCH comprises the scheduling latency, and the scheduling latency is greater than or equal to switching latency of the first-type terminal device.

21. The data transmission method according to claim 20, further comprising:
stopping, by the network device, sending downlink information to the first-type terminal device within the switching latency.

22. The data transmission method according to claim 13, further comprising:
in response to the first-type terminal device receiving the PDSCH in the second band width part, stopping, by the network device, sending a PDCCH to the first-type terminal device in the first band width part.

23. The data transmission method according to claim 13, further comprising:
determining, by the network device, a timing at which the first-type terminal device switches from the second band width part to the first band width part; and
sending, by the network device after the timing, a PDCCH to the first-type terminal device in the first band width part.

24-40. (canceled)

41. Communication equipment, comprising:
an antenna;
a memory; and
a processor, communicatively connected to the antenna and the memory, and configured to execute computer executable instructions stored in the memory to control reception and transmission of the antenna and implement the computer executable instructions comprising:
monitoring a first physical downlink control channel (PDCCH) in a first band width part, and receiving a physical downlink shared channel (PDSCH) in a second band width part based on the first PDCCH, wherein a band width of the first PDCCH is located in a receiving band width of a terminal device, and the first PDCCH is used for scheduling the PDSCH.

42. (canceled)
